(19) United States
(12) Patent Application Publication
(10) Pub. No.: US 2009/0179170 A1
(43) Pub. Date: Jul. 16, 2009

(54) Semispherical Valve for Reciprocating Compressor and Pumps

(76) Inventor: H. Eugene Bassett, Sugar Land, TX (US)

Correspondence Address: SYSTEM DYNAMICS, 4126 HENLEY COURT, SUGAR LAND, TX, 77479, US

(21) Appl. No.: 11/539,672

(22) Filed: Oct. 9, 2006

(51) Int. Cl. F16K 1/00

(52) U.S. Cl. 251/318

(57) ABSTRACT

A valve for inlet or outlet of gas and liquid for compressors and pumps comprises a semispherical seal element reciprocating between the stop surfaces and the opposed seating surface. A single spring engages the seal element to bias the seal element toward its seating surfaces.

### BACKGROUND OF THE INVENTION

The present invention pertains to valves that may be used for intake or outlet of gases or liquids for reciprocating compressors and pumps. The operative portion of such a compressor and pump includes at least one piston and cylinder assembly, and the intake and exhaust valves are typically located at or near one of the cylinder heads. It is commonly known to use the same form of valve for both inlet and outlet by simply reversing the position of the valve for the two uses. One such valve is disclosed in Inventor's prior U.S. Pat. No. 5,511,583 which has annular valve elements. The present invention differs in that the valve elements are not annular but cylindrical, have a semispherical seating surface and a matching semispherical element seating surface. Also, unlike U.S. Pat. No. 5,511,583 that has multiple springs per element and the present invention has a single spring per element biasing it closed, i.e. toward its seating surface in to and fro movement.

The present invention is similar to what is generally known as “poppet-type”. The valve elements of traditional poppet valves are more or less mushroom shaped, with the head of the mushroom defining the sealing surface for engagement with the valve seat, and the cylindrical stem of the mushroom being utilized for guidance of the valve element in its reciprocating movement. These valves elements lift is usually 0.250 inch or more from fully seated to full open in order to achieving low pressure drop. The high lift and large seat flow hole diameter provide a relatively large available flow area for the gases. Reducing the lift, as is often required in process market results in loss of efficiency. For this reason the traditional poppet valves are limited to low differential pressure and low speed applications. The present invention valve elements are different from traditional poppet valves in the following respects:

They are completely cylindrical without mushroom head.

The seating surface is semispherical.

The flow holes are smaller.

There are a greater number of flow holes.

The maximum lift area is equal to the flow hole area.

The above differences remove the limitations of traditional poppet valves.

### SUMMARY OF THE INVENTION

A compressor and pump inlet or outlet valve according to the present invention comprises a seating plate and a guard plate removable attached in opposed relation to make up the valve body. The seating plate has a plurality of holes extending from an outer side of the seating plate to the inner side. The guard plate defines a respective stop surface generally opposed to but spaced from the seating surfaces associated with each seat hole. The guard plate also has flow passages from the inner to the outer side thereof and communicating with the spaces between the stop surfaces and the seating surfaces. A respective cylindrical valve element reciprocates between the stop surfaces and the respective opposed seating surfaces and have sealing surfaces sized and shaped to engage and seal against the respective seating surfaces. A single spring carried by the guard plate or valve element each engages a respective valve element to bias it toward the respective sealing surfaces. A replaceable ring with semispherical first seating surface in the seat plate significantly improves application possibilities and further reduces initial as well as future maintenance cost. This ring may be of almost any material including exotic material with minimal cost increases because low cost seat plate material may still be applied.

The cylindrical valve elements need not be fully customized, but can be off the shelf items, or made from off the shelf items, thereby decreasing production costs. Furthermore, a single size of cylindrical valve elements can be used not only throughout a given valve, but also for a range of valves of different sizes. Although inventor's prior U.S. Patent. No. 5,511,583 has performed well it is desirable to further upgrade and reduce manufacturing costs to meet new industry demands. The present invention addresses these needs by eliminating costly milling and further standardization of critical components.

Various objects, features and advantages of the invention will be made apparent by the following detailed description, the drawings, and the claims.

### DETAILED DESCRIPTION

### BRIEF DESCRIPTION OF THE DRAWINGS

FIG. 1 is a top plan view of the device.

FIGS. 2, 3, 4, and 5 are longitudinal cross-sectional views of the present invention taken along the line 1-1 in FIG. 1 showing the device in the open position.

FIG. 2 is the preferred embodiment that includes a replaceable annular ring 3 and spring is carried by the guard plate.

FIG. 3 is same as FIG. 2 without a replaceable annular ring 3.

FIG. 4 is same as FIG. 2 with replaceable annular ring 3 and thicker valve element 16 to carry a spring.

FIG. 5 is same as FIG. 4 without a replaceable annular ring 3.

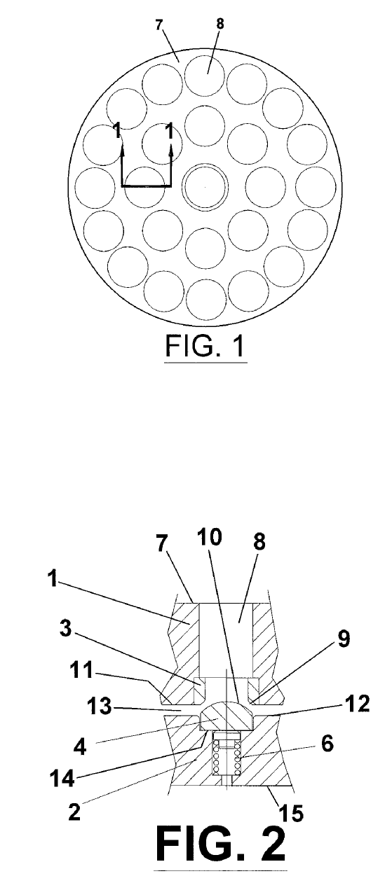

FIGS. 1 and 2 illustrate a first embodiment of compressor valve according to the present invention. As shown, this, and all the other embodiments disclosed herein can be oriented for use as an intake or outlet valve by simply reversing its orientation as is well known in the art. The valve comprises as seating plate 1 and a guard plate 2 secured together in opposing relation to form the valve case. The seating plate has a plurality of holes 8 extending from its outer surface 7. The guard plate 2 includes a plurality of cylindrical guides extending from its inner surface 12 and generally aligned with holes 8 in seating plate. A cylindrical replaceable annular ring 3 with integral semispherical first seating surface 9 mates with second seating surface 10 when the valve is in the closed position.

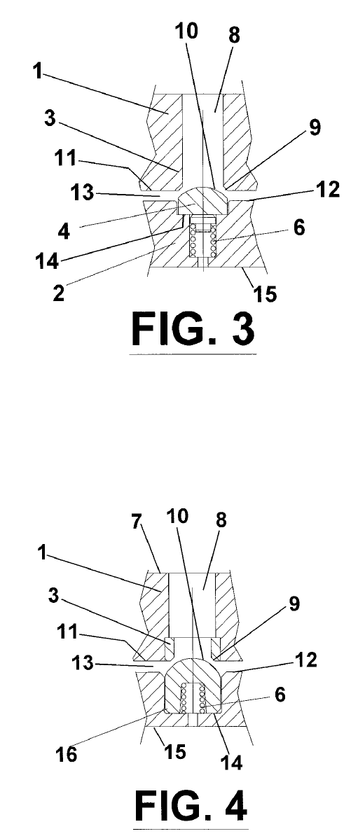

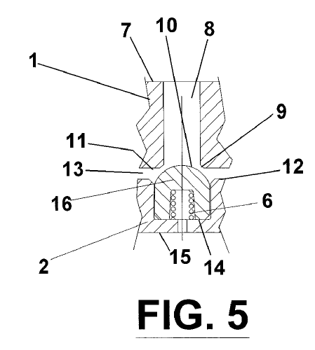

Referring next to FIGS. 1 and 3, there is shown a second embodiment of the invention, which is generally the same as the first embodiment, except that the cylindrical replaceable annular ring 3 is not used. The plurality of holes are machined directly on the inner side of seat plate 1 to form the semispherical first seating surface 9. While the foregoing represent exemplary and currently preferred embodiments of the present invention, numerous modifications will suggest themselves to those of skill in the art. Accordingly, it is intended that the scope of the invention be limited only by the following claims.

What is claimed is:

1. A valve for inlet or outlet of gas and liquids with respect to reciprocating compressors and pumps comprising;
a. a ring; said ring is annular and replaceable with a semispherical first seating surface;
b. a seating plate; said seating plate having a plurality of holes extending from an outer side of said seating plate and intersecting a plurality of said ring;
c. a guard plate; said guard plate defining a stop surface opposed to and spaced from said seating plate and having flow passages through said guard plate from an inner side thereof to an outer side thereof and communicating with the spaces between said stop surface and said first seating surface;
d. a valve element; said valve element being cylindrical about it's longitudinal axis and with a second semispherical seating surface sized and shaped to engage and seal against said first seating surface, said valve element reciprocates between each said stop surface and the opposed said first seating surface, and a spring carried by said guard plate to bias said valve element toward said first seating surface.

2. A device according to claim 1 wherein the seating plate consists of a plurality of holes extending from an outer side of said seating plate without said ring, but with semispherical first seating surface on the inner side of said seating plate.

3. A device according to claim 1 wherein said spring is carried by said valve element.

4. A device according to claim 2 wherein said spring is carried by said valve element.
